(19) United States
(12) Patent Application Publication
(10) Pub. No.: US 2009/0286492 A1
(43) Pub. Date: Nov. 19, 2009

(54) RF SWITCH AND TRANSMIT AND RECEIVE MODULE COMPRISING SUCH A SWITCH

(75) Inventors: Benoit Mallet-Guy, Paris (FR); Claude Auric, Chateaufort (FR); Philippe Dueme, Orsay (FR); Jean-Philippe Plaze, Bois D'arcy (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/467,994

(22) Filed: May 18, 2009

(30) Foreign Application Priority Data
May 16, 2008 (FR) 0802667

(51) Int. Cl. H04B 1/44

(52) U.S. Cl. 455/83

(57) ABSTRACT

The present invention relates to a device for switching an RF signal. It also relates to a transmit and receive module comprising such a switch. The device includes at least one branch linking a first pole to a second pole, a branch comprising a conducting line coupled to a reference potential, it comprises at least one Gallium Nitride (GaN) semi-conductor elementary switch, for example a transistor, linking the line to the reference potential, the RF signal propagating along the line when the semi-conductor is driven to the on state. In the transmit and receive module, the device links the transmit pathway and the receive pathway to an antenna. The invention applies notably in transmit and receive modules of airborne systems operating in a broad band of frequencies or in a narrow band.

### CROSS-REFERENCE TO RELATED APPLICATION

The present application claims the benefit of French Patent Application No. 0802667, filed May 16, 2008, which is hereby incorporated by reference in its entirety.

### BACKGROUND OF THE INVENTION

The present invention relates to a device for switching an RF signal. It also relates to a transmit and receive module comprising such a device. It applies notably in transmit and receive modules of airborne systems operating in a broad band of frequencies or in a narrow band.

Radars or other airborne electromagnetic systems operate depending on the applications in a broad band of frequencies or conversely in a narrow band. The transmit and receive functions of these electromagnetic systems are generally implanted in specific modules.

One of the functions common to all these types of transmit and receive modules, denoted T/R subsequently, is discrimination of the signals which allows a module:
in transmit mode to send the processed signal, amplified by a power amplifier, to the antenna so as thereafter to be propagated in the exterior medium;
in receive mode to receive a reflected signal arising from the antenna so as thereafter to amplify it, by means of a low noise amplifier, so that it is processed by the radar processing means for example.

In transmit mode, the level of the signal provided to the antenna is very high whereas that received by the antenna in receive mode is very low. By way of example, the peak power involved may attain several tens of kilowatts or even more and only a few milliwatts in the second case.

Two major constraints then appear during the design and construction of the device ensuring this discrimination of the signals in a T/R module:
on the one hand it must process signals of very large power and must therefore be able to support these large powers;
on the other hand it must ensure strong discrimination between two signals possessing a significant discrepancy in power level.

Furthermore, this device must possess good performance or characteristics as regards:
the switching times;
the isolation between the transmit and receive pathways;
the insertion losses;
the volume and weight, notably for airborne applications.

The two constraints stated above greatly influence the level of this performance and these characteristics. They also have a strong impact in the architecture of a T/R module.

The known solutions deal differently with the design of a module, depending on whether it is intended to operate in narrowband or in broadband. In the case of a narrowband application, the discrimination function is generally designed in two parts:
a first part deals with the steering of the signal to the foot of the antenna between the transmit and receive pathways;
a second part covers the switching of the processing of the signal depending on the operating mode.

The steering is carried out by means of one or more RF circulators. One of the main drawbacks of this solution is notably the use of these circulators which are bulky and unwieldy components, and therefore penalizing for an airborne application.

In the case of applications to broadband, the use of circulators is much more limited. Depending on the intended frequency band and its width, that is to say the ratio of the minimum frequency to the maximum frequency of use, either no circulator exists (because of the overly large band ratio), or the existing circulators possess a bulk and weight that are inappropriate for an airborne application. PIN-diode power switches exist, but they are not generally used since they consume a great deal of current, do not switch rapidly and have a number of switchings limited to 1000 per second. The only remaining solution is then to ensure the steering of the signals by using two different antennas, one to transmit and one to receive. A drawback is clearly apparent, namely the need to duplicate the antennas and the transmit and receive pathways.

### SUMMARY OF THE INVENTION

An aim of the invention is notably to alleviate the aforesaid drawbacks while making it possible to circumvent or to decrease the effect and the impact of the constraints mentioned above. For this purpose, the subject of the invention is a device for switching an RF signal comprising at least one branch linking a first pole to a second pole, where a branch comprising a conducting line coupled to a reference potential, it comprises at least one Gallium Nitride (GaN) semi-conductor elementary switch linking the line to the reference potential, the signal propagating along the line when the semi-conductor is driven to the on state ( Q̅).

The elementary switches are for example distributed along the conducting line, the points of connections of two consecutive switches being substantially a quarter of the wavelength of the signal apart.

A branch can comprise at least one Gallium Nitride (GaN) elementary switch in series between its two poles driven into an inverse state (Q) opposite to the previous one.

In a particular embodiment, at least one passive four-pole is connected in series between the two poles of a branch.

An elementary switch is for example a Gallium Nitride (GaN) field-effect transistor.

The sources of the transistors are for example linked on the conducting line, the drains being linked to the reference potential, the on state of a transistor being controlled by its gate voltage.

The drains of the transistors are for example linked on the conducting line, the sources being linked to the reference potential, the on state of a transistor being controlled by its gate voltage.

In a possible embodiment, the device comprises for example a first branch linking a first pole and a second pole and a second branch linking this first pole and a third pole.

In another possible embodiment, the device is of the four-pole type, comprising four branches linking four poles pairwise.

The subject of the invention is also a transmit and receive module comprising at least one transmit pathway for an RF signal and one receive pathway for an RF signal, the said module comprising a switching device such as described above and comprising a first branch linking the transmit pathway to a point able to be connected to an antenna and a second branch linking this point to the receive pathway.

In a particular embodiment, the transmit pathway comprises a power amplifier linked upstream to a point able to be connected to processing means and the receive pathway comprises a low noise amplifier linked downstream to a point able to be connected to processing means.

### BRIEF DESCRIPTION OF THE DRAWINGS

Other characteristics and advantages of the invention will become apparent with the aid of the description which follows offered in relation to appended drawings which represent:

FIG. 1, an illustration of a discrimination and switching device of a transmit and receive module according to the prior art for a narrowband application;

FIG. 2, an illustration of a discrimination and switching device of a transmit and receive module according to the prior art for a broadband application;

FIG. 3, an illustration of the principle for embodying a switching device according to an embodiment of the invention;

FIGS. 4a, 4b and 4c, examples of switches that can be embodied according to the invention;

FIGS. 5a and 5b, two exemplary embodiments of branches of switches according to the invention;

FIG. 6, a switch of four-pole type embodied according to the invention.

### MORE DETAILED DESCRIPTION

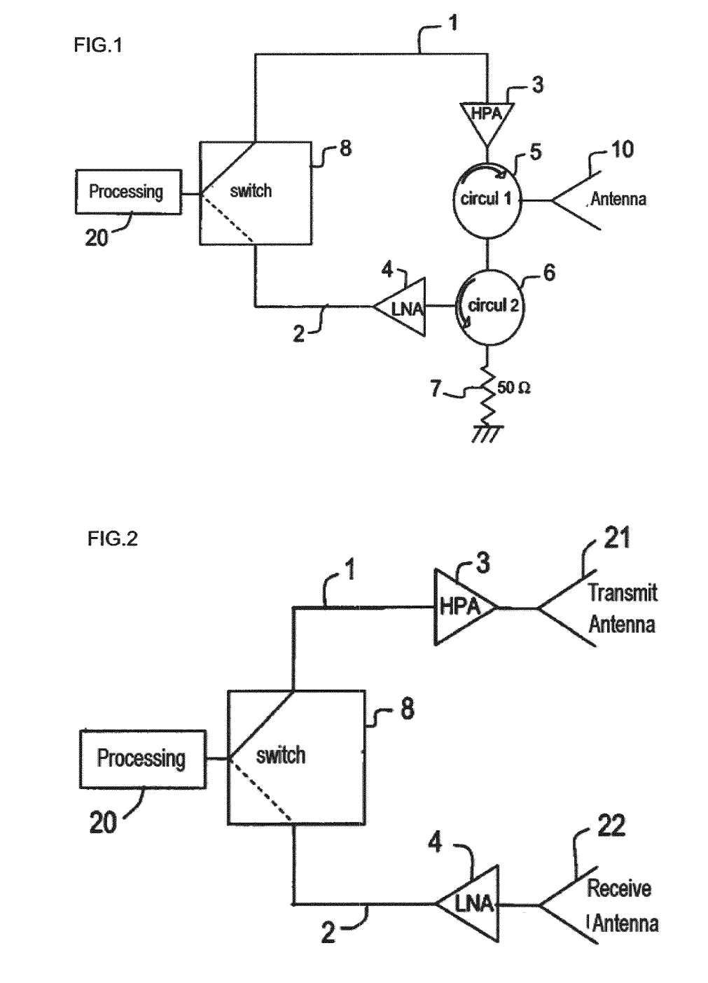

FIG. 1 illustrates through a schematic a discrimination device of a T/R module according to the prior art, for a narrowband application for example in a case of operating in the X band. As indicated above, this device performs on the one hand the steering of the signals to the foot of the antenna 10 between the transmit pathway 1 and the receive pathway 2 and on the other hand the switching of the processing of the signals 20 according to the operating mode. The transmit 1 and receive 2 pathways are linked to the processing means 20 by a switch 8, the latter switching one or the other of these pathways on the processing according to the operating mode in progress, transmission or reception.

The transmit pathway comprises notably a power amplifier 3 intended to amplify the low power signal arising from the processing 20, the amplified signal being intended to be transmitted by the antenna. The receive pathway comprises notably a low noise amplifier 4 for amplifying the low power signal received by the antenna and destined for processing. The processing means 20 comprise all the known components necessary for the various applications envisaged, and notably the appropriate converters and interfaces as well as adequate calculation means.

In the example of FIG. 1, the steering is performed by means of two RF circulators 5, 6. The first circulator 5 receives on a first input the amplified signals arising from the power amplifier 3. The second input/output of the circulator 5 is linked to the antenna 1 so that the amplified signal is directed towards the latter. The switching function is placed upstream of the power amplifier 3. The signals which pass through the switch 8 can then be of low power.

On reception, the signals arising from the antenna enter on this second input/output so as to be directed towards another output linked to a first input of the second circulator 6. The signal received is directed inside the circulator towards an output linked to the receive pathway and notably to the input of the low noise amplifier 4. The third and last input/output of the second circulator is linked to a 50-ohm load 7. This second circulator enhances the isolation between the transmit and receive pathway. The number of circulators used depends on the isolation level sought between the two pathways 1, 2. In the case of minimum isolation, the output of the first circulator 5 is linked directly to the input of the low noise amplifier 4.

The use of a circulator therefore makes it possible to dissociate at the level of the antenna 1 the transmit and receive paths. Circulators being passive elements, they are naturally able to pass a signal of large power coming from the power amplifier 3. However, the circulators are penalizing because of their weight and bulk, notably for airborne applications.

FIG. 2 illustrates the case of an exemplary embodiment according to the prior art for a broadband application. Because of the limitation on the use of circulators, the remaining solution is to ensure the steering by using two different antennas 21, 22, one to transmit 21 and the other to receive 22. The transmit 1 and receive 2 pathways, comprising respectively a power amplifier 3 and a low noise amplifier 4, are still linked to the processing means 20 via the switch 8. The output of the power amplifier 3 is linked to the transmit antenna 21 and the input of the low noise amplifier 4 is linked to the output of the receive antenna 22. As indicated above, a drawback of this solution is the need to duplicate the antennas and the transmit and receive pathways associated with them.

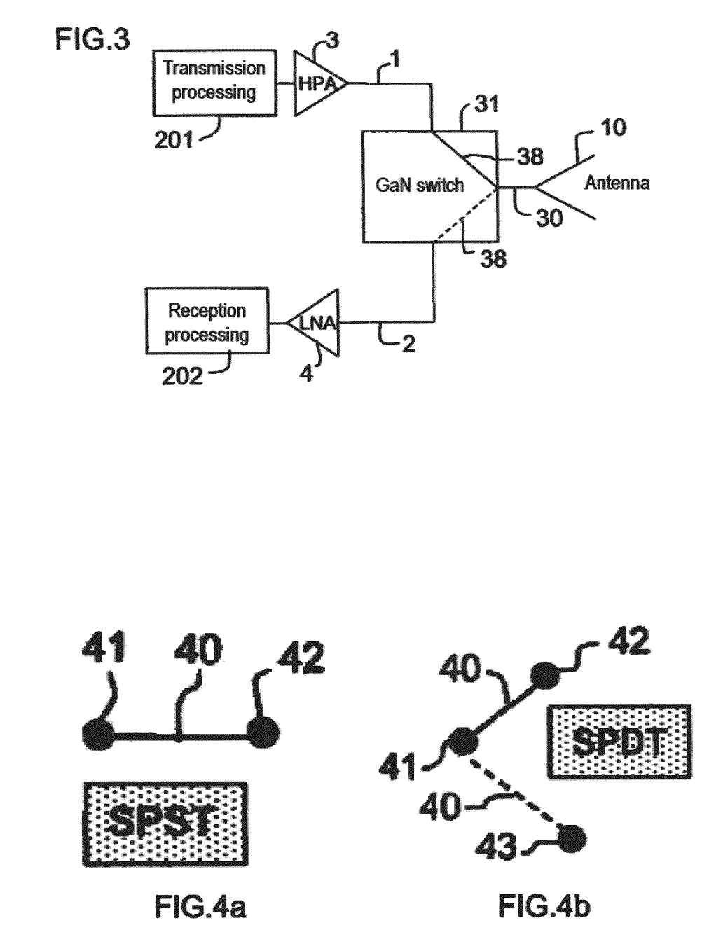

FIG. 3 illustrates the principle for embodying a device according to the invention. The invention uses a switch 31 based on diodes or transistors fabricated using a so-called “large gap” semi-conductor, a known type being a Gallium Nitride GaN semi-conductor. Semi-conductors are notably characterized by their forbidden band or gap, which separates the last occupied states of the valence band and the following free states in the conduction band. A distinction is then made between small-gap semi-conductors which have a forbidden band of much lower than 1 eV and large-gap semi-conductors which have a much higher forbidden band, for example of the order of 3 eV to 5 eV.

Gallium Nitride GaN diodes or transistors are capable of operating with a signal of very large power while possessing the same levels of performance as those made of silicon or gallium arsenide for example. This performance relates notably to losses, isolation, switching times, bulk and weight. The capabilities of GaN semi-conductors to operate with very large powers originate from the very high value of their breakdown voltages which is of the order of 150 V. This high voltage value is due to the large value of the forbidden band of the GaN semi-conductor used in the form of a heterojunction of AlGaN—GaN type at the level of the active layer.

According to the invention the switch 31 is placed at the foot of the antenna 10 as illustrated by FIG. 3, that is to say linked directly to this antenna. The architecture of a T/R module is then identical whatever the operating frequency band. The output of the power amplifier 3 is linked to an input of the switch 31 and the input of the low noise amplifier 4 is linked to its output. Depending on the operating mode, transmit or receive, the switch links the transmit pathway 1 to the antenna or the antenna to the receive pathway 2. These pathways 1, 2 are moreover linked upstream and downstream to the transmission processing means 201 and to the reception processing means 202 which may be grouped together in one and the same processing block 20.

The switch therefore comprises a branch 38 linking the transmit pathway to a point 30 able to be linked to the antenna, notably to the foot of the antenna, and it comprises a second branch 39 linking this point 30 to the receive pathway.

For a narrowband application, the use of circulators is then no longer necessary. The T/R module gains greatly in terms of bulk and weight. It is moreover no longer confronted with the phenomena of so-called “droop” pulses generated by the circulators on transmission.

For a broadband application, it becomes possible to use the same antenna for transmission and reception while retaining good performance as regards switching time, insertion losses and isolation.

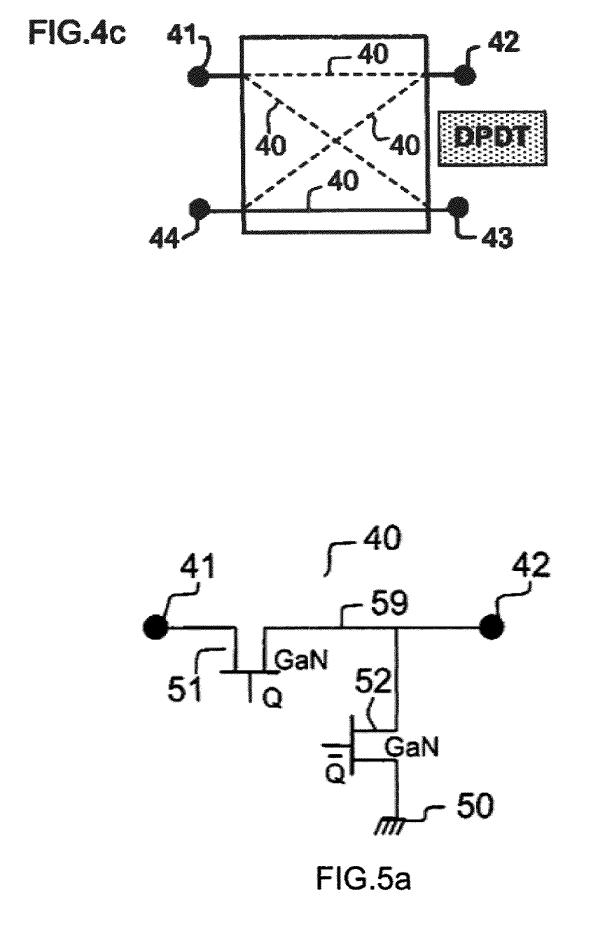

FIGS. 4a, 4b and 4c present examples of switches using GaN diodes or transistors. The embodiment is the same as for those composed of silicon or gallium arsenide diodes or transistors. An appreciable difference in their use is the level of the voltages to be applied to the transistors: 0 volts in on mode and −20 volts in off mode, instead of 0V and −2.5V for AsGa technology notably. The switches embodied may be:
of the SPST (Single Pole Single Throw) bipolar type as illustrated by FIG. 4a, ensuring simple switching between a first pole 41 and a second pole 42;
of the SPDT (Single Pole Double Throw) tripolar type as illustrated by FIG. 4b, ensuring a switching between a first pole 41 and a second pole 42 on the one hand and between a third pole 43 on the other hand;
of the DPDT (Double Pole Double Throw) four-pole type as illustrated by FIG. 4c, ensuring a double cross-switching between two poles 41, 44 and two other poles 42, 43.

Each switching arm, or branch, 40 is composed of GaN transistors which are placed in series or in parallel.

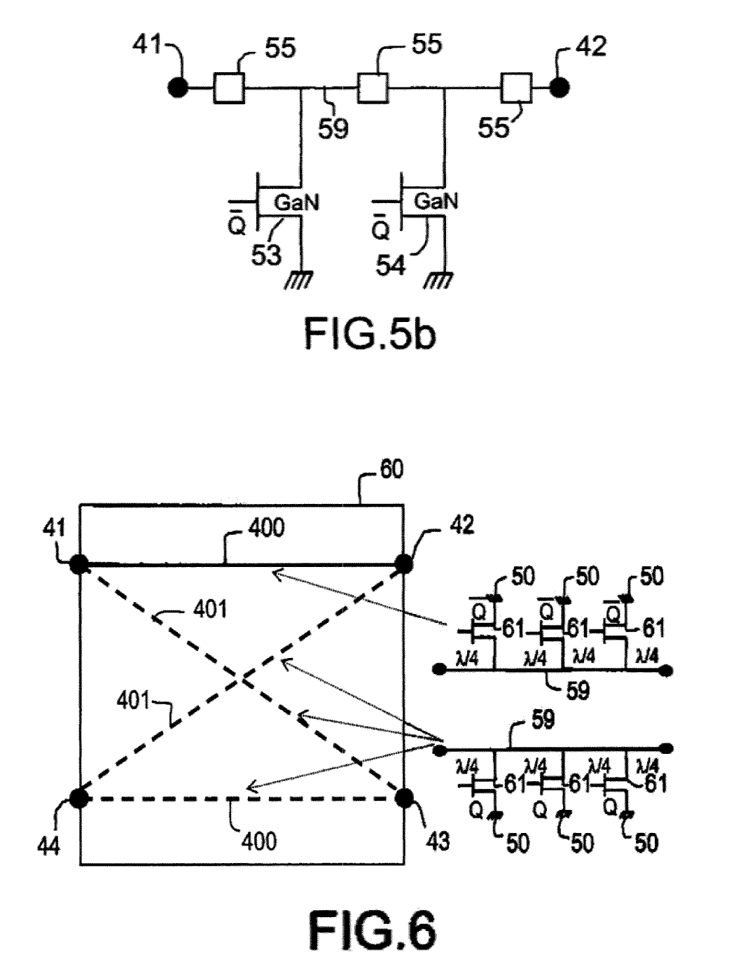

FIGS. 5a and 5b illustrate two exemplary embodiments of switching arms 40 with GaN field-effect transistors. An RF signal propagates along these arms, between a conducting line 59 and a reference potential 50, for example the mechanical earth.

In the example of FIG. 5a, the arm 40 comprises on the conducting line a transistor 51 in series between the two poles 41, 42. The drain is for example linked to the first pole 41 and the source to the second pole.

When the switch is in the on state, the transistor 51 is in the on state. In this case a voltage is applied between the gate of the transistor and the source, equal to −20V. The signal passes in this case from the first pole to the second pole. The transistor is in the off state when the voltage on its gate is equal to 0V notably.

A second transistor 52 is connected in parallel. More precisely, this transistor 52 is connected between the source or the drain of the first transistor and the reference potential 50, the zero potential for example or the mechanical earth. The drives Q and Q of the transistors 51, 52 are inverted so that when one is on the other is off and vice versa. Thus when the first transistor 51 is on, continuity of transmission is ensured between the two poles. The second transistor 52 being off, the conducting line is isolated from the mechanical earth 50. The signal therefore propagates for example from the first pole 41 to the second pole.

When the first transistor 51 is driven to the off state, the transmission of the signal is no longer ensured through cutoff of the conducting line. Moreover, the second transistor 52 being driven into the on state, the potential of the line is reduced to that of the mechanical earth 50 for example, thus preventing any propagation of an RF signal.

FIG. 5b presents a case where several elementary switches formed of the cells 55 are connected in series between the poles 41, 42, three in the example of this figure. The cells 53 and 54, linking the line 59 to the reference potential, consist of transistors connected between the cells 55 and the reference potential with inverse commands Q̅. The cells 55 can be either simple transistors like that 51 of FIG. 5a, or passive dipoles. In this case, the passive dipoles are often constituted of a transmission line of length λ/4, λ being the length of the wave transmitted or received. Their role is then to improve the isolation performance of the switch thus constituted.

The circuit technology used can be either of hybrid type, or of integrated type, MMIC for example, depending on the intended application. The choice and the size of the number of GaN transistors is for example determined as a function of the performance sought in terms of efficacy as regards power, isolation and duration of switching notably. Depending on the embodiments, the lines 59 may be disposed facing a conducting plane brought to the reference potential 50, forming for example an earth plane.

FIG. 6 presents an exemplary embodiment of a DPDT switch 60 such as illustrated by FIG. 4c. In this exemplary embodiment, the arms 400, 401 comprise distributed transistors 61. Stated otherwise, the GaN transistors are connected for example in common source configuration on the conducting line 59 linking the two poles of a switching branch. That is to say, the sources of the transistors 61 are linked to the line 59. The drains of the transistors are linked to the reference potential 50. The polarity of the transistors could be inverted in such a way that the drains are connected to the line 59. The gate of the transistors is linked to control means, not represented, conveying the voltage level necessary for tuning off and on. When the transistors are in the off state, controlled for example by a signal Q̅, the RF signal propagates along the line by means of the drain-source capacitances of the transistors, connected between the line 59 and the mechanical earth 50 for example. To optimize the distribution and reduce to the maximum the standing wave ratios these capacitances are spaced λ/4 apart, λ being the length of the wave transmitted or received. In practice, it is the points of connection of the transistors to the line 59, the sources or the drains, which are spaced λ/4 apart. In the exemplary representation of FIG. 6, a branch 400 propagates the signal between a pole 41 and another pole 42. The other branches 401 do not propagate any signal, since their distributed transistors are controlled by the signal Q, the inverse of the signal Q controlling the transistors of the first branch 400, and are therefore in the on state.

This solution with distributed transistors has been described for a switching device of the DPDT four-pole type, it can apply to other types of switching devices, SPST or SPDT notably. The invention has also been described with elementary switches which are GaN transistors. It can also apply in respect of other GaN semi-conductors provided that they can be turned on and off. GaN diodes could for example be used.

1. A device having at least one branch linking a first pole to a second pole, for switching an RF signal between said poles, wherein the at least one branch comprises:
a conducting line to couple the first pole to the second pole, the conducting line comprising a switch element, the switch element having a first port in communication with the first pole, a second port in communication with the second pole, and a control port, wherein the RF signal propagates along the conducting line when the switch element is driven to a state that is on; and
a Gallium Nitride semi-conductor switch element to connect, at a point of connection, the conducting line to the reference potential, wherein the point of connection is connected to one of the first port and second port of the switch element of the conducting line, and wherein the Gallium Nitride semi-conductor switch element is driven to a state that is opposite to the state of the switch element of the conducting line.

2. The device according to claim 1, wherein a plurality of Gallium Nitride semi-conductor switch elements are connected to the conducting line, the device having a point of connection between the conducting line and each of the Gallium Nitride semi-conductor switch elements, to form a plurality of points of connection, wherein consecutive points of connections within the plurality of points of connection are spaced apart by substantially one quarter-wavelength of the RF signal.

3. The device according to claim 1, wherein at least one passive dipole is connected in series between the first and second poles of a branch.

4. The device according to claim 1, wherein the switch element comprises a Gallium Nitride field-effect transistor having a source, a gate, and a drain.

5. The device according to claim 4, wherein the source of the Gallium Nitride field-effect transistor is linked to the conducting line, the drain of the transistor is linked to the reference potential, and a gate voltage of the transistor controls the state of the transistor.

6. The device according to claim 4, wherein the drain of the Gallium Nitride field-effect transistor is linked to the conducting line, the source linked to the reference potential, and an on state of the transistor is controlled by its gate voltage.

7. The device according to claim 1, wherein the device comprises a first branch linking a first pole to a second pole and a second branch linking the first pole to a third pole.

8. The device according to claim 1, wherein the device comprises a DPDT switch having four branches to link each of two input poles to each of two output poles.

9. A transmit and receive module comprising:
at least one transmit pathway for an RF signal;
one receive pathway for an RF signal;
at least a first and second branch, respectively linking a first pole to a second pole, wherein each of the at least first and second branches comprise:
a conducting line to couple the first pole to the second pole, the conducting line comprising a switch element, the switch having a first port in communication with the first pole, a second port in communication with the second pole, and a control port, wherein the RF signal propagates along the conducting line when the switch element is driven to a state that is on; and
a Gallium Nitride semi-conductor switch element to connect, at a point of connection, the conducting line to the reference potential, wherein the point of connection is connected to one of the first port and second port of the switch element of the conducting line, and wherein the Gallium Nitride semi-conductor switch element is driven to a state that is opposite to the state of the switch element of the conducting line
wherein the first branch links the transmit pathway to a an antenna interface and the second branch links the antenna interface to the receive pathway.

10. The transmit and receive module according to claim 9, wherein the transmit pathway comprises a power amplifier having an interface to a transmission processor, and the receive pathway comprises a low noise amplifier having an interface to a reception processor.

11. A device for switching an RF signal, the device having at least one branch linking a first pole to a second pole, wherein each of the at least one branch comprises:
a conducting line to couple the first pole to the second pole; and
a plurality of Gallium Nitride semi-conductor switch elements to link the conducting line to the reference potential, wherein the RF signal propagates along the conducting line when each of the plurality of Gallium Nitride semi-conductor switch element is driven to an off state;
wherein the plurality of Gallium Nitride semi-conductor switch elements are distributed along the conducting line, the device having a point of connection between the conducting line and each of the plurality of Gallium Nitride semi-conductor switch elements to form a plurality of points of connection, wherein consecutive points of connections within the plurality of points of connection are spaced apart by substantially one quarter-wavelength of the RF signal.
